(19) United States
(12) Patent Application Publication
(10) Pub. No.: US 2011/0253589 A1
(43) Pub. Date: Oct. 20, 2011

(54) IMPACT-ABSORBING PACKAGE

(75) Inventors: H. Richard Webb, St. Albans, MO (US); Wayne S. Pratt, Fenton, MO (US)

(73) Assignee: Innovative Enterprises, Inc, Washington, MO (US)

(21) Appl. No.: 13/086,790

(22) Filed: Apr. 14, 2011

Related U.S. Application Data
(60) Provisional application No. 61/324,611, filed on Apr. 15, 2010.

(51) Int. Cl. B65D 81/113; B32B 3/12

(52) U.S. Cl. 206/590; 206/592; 428/116

(57) ABSTRACT

A package for holding and protecting a can includes a six-wall, eight-corner box and inserts in the box where they capture the can at each end of the box. Each insert includes a paper honeycomb panel that corresponds in shape to the cross-sectional shape of the interior of the box and a rigid backing that is attached firmly to one face of the panel. The backing is die cut to provide a segment that corresponds in shape to the ends of the can, with the cut extending partially into the honeycomb cells as well. The cut segment of the backing is forced into the underlying honeycomb cells to provide a pocket that snugly receives an end of the can and a pad behind the pocket. Multiple inserts may be derived from a slab having intermittent cuts at which individual inserts may be detached.

### CROSS-REFERENCE TO RELATED APPLICATIONS

This application derives priority from and otherwise claims the benefit of U.S. provisional application 61/324,611, filed Apr. 15, 2010, which application is incorporated by reference.

### BACKGROUND OF THE INVENTION

This invention relates in general to packaging and more particularly to a package that is capable of protecting its contents when subjected to substantial impacts.

The common quart and one-gallon cans provided with a friction-fitted lids see widespread use as containers for a variety of materials that may take the form of liquids, pastes, gels, or even solids in a granular or similar form. Some of those materials, if toxic or corrosive, can present a hazard if allowed to escape. Others, such as paint, must be contained, lest if allowed to escape, they will soil or ruin surfaces that they contact. Indeed, the shipment and storage of paint represents a major use of such containers.

Often a one-gallon container holding a product, either hazardous or otherwise, is shipped in a box formed from corrugated paperboard and having the typical six-panel, eight-corner, configuration. The box may contain one or more cans. The boxes commonly used for paints hold one, two or four one-gallon cans, sometimes with corrugated paperboard or expanded polymer separators between the cans. The typical box provides only minimal protection for the can or cans in it. When the box is subjected to an impact, even a minor one, a can within it can easily dent, and much worse, the impact, if strong enough, may rupture the can or dislodge its lid. Indeed, in some packages the cans have clips or rings to supplement the friction fits and better retain the lids.

### BRIEF DESCRIPTION OF THE SEVERAL VIEWS OF THE DRAWINGS

FIG. 1 is a perspective view of a package constructed in accordance with and embodying the present invention;

FIG. 2 is an exploded perspective view of the package together with a can protected by the package.

FIG. 3 is a sectional view of the package with the can in it;

FIG. 4 is a perspective view of an insert for the package with its backing broken away;

FIG. 5 is a fragmentary perspective view of the honeycomb panel for the insert;

FIG. 6 is an exploded perspective view of a package suitable for holding two cans;

FIG. 7 is an exploded perspective view of a package suitable for holding four cans; and

FIG. 8 shows a slab from which the inserts for the packages may be cut.

### DESCRIPTION OF THE INVENTION

Referring now to the drawings, a package A (FIGS. 1 & 2) contains and confines a can B, providing a good measure of protection for the can B, even when the package A is subjected to substantial impacts. The can B possesses the typical configuration in that it has a cylindrical side wall 2, a fixed end wall 4 at one end of the sidewall 2, and a friction-fitted lid 6 at the other end of the side wall 2, with the end wall 4 and lid 6 both being essentially planar and circular. It may come in a variety of sizes, one-quart and one gallon being the most common. But the can B may be smaller or larger, even a five gallon bucket with its lid held by tabs. Moreover, it may be a container of a configuration other an cylindrical. For example, it may have a rectangular or oblong or some other cross-sectional configuration. The package A and the can B have a common longitudinal axis X. The package A includes a box 10 and upper and lower inserts 12 and 14 within the box 10. The inserts 12 and 14 confine the can B, both longitudinally and laterally, and the box 10 in turn confines the inserts 12 and 14.

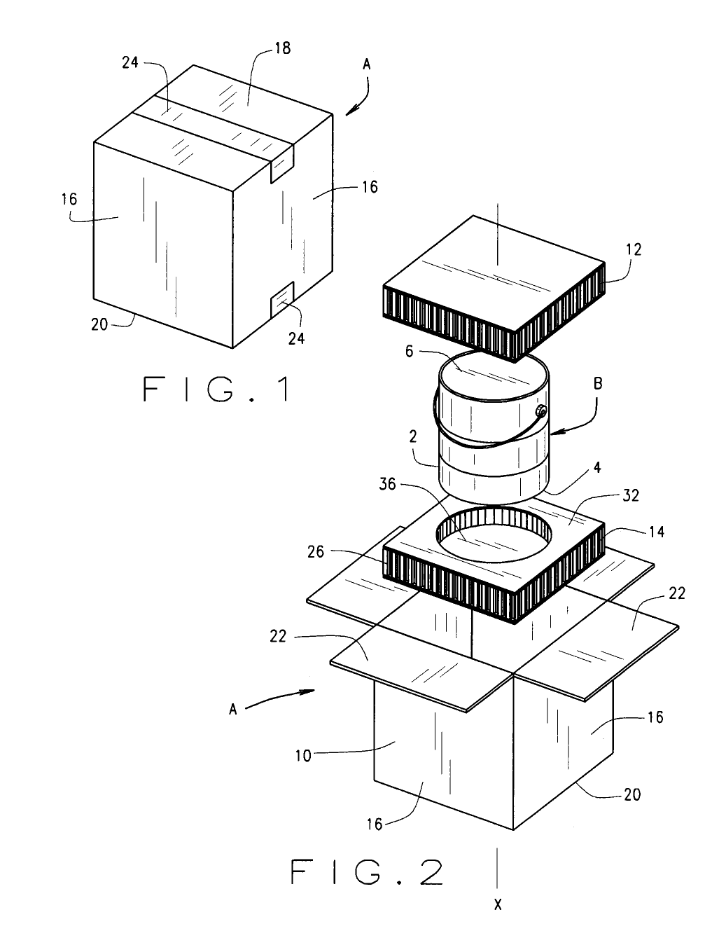

The box 10 is preferably formed from corrugated paperboard in the typical eight corner configuration with rectangular cross sections. As such it possesses four rectangular side walls 16 and in addition rectangular upper and lower end walls 18 and 20 (FIGS. 2 & 3) formed by overlapping flaps 22 (FIG. 1) that are attached to the side walls 16 and secured in overlapping relation, preferably by strips 24 of adhesive-backed tape.

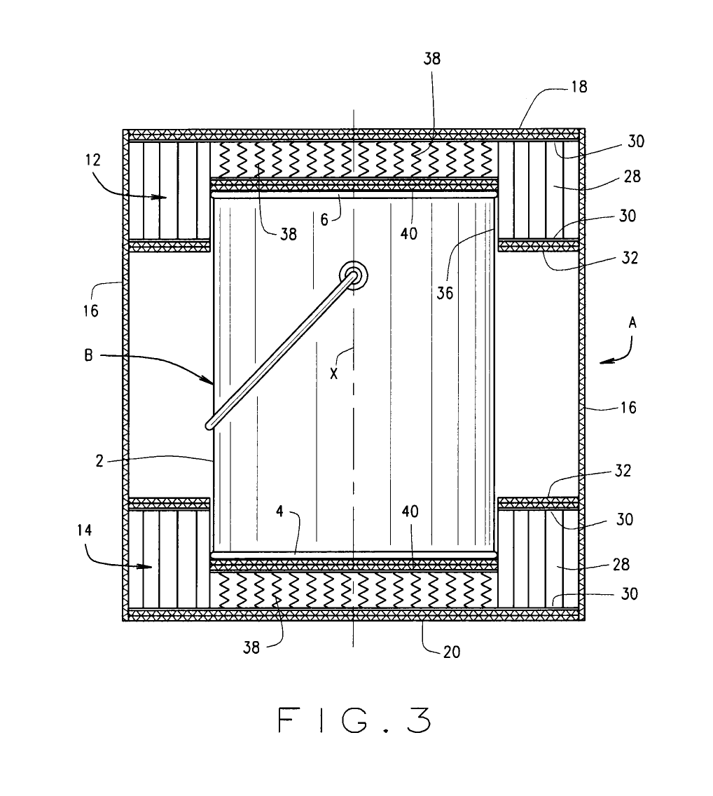

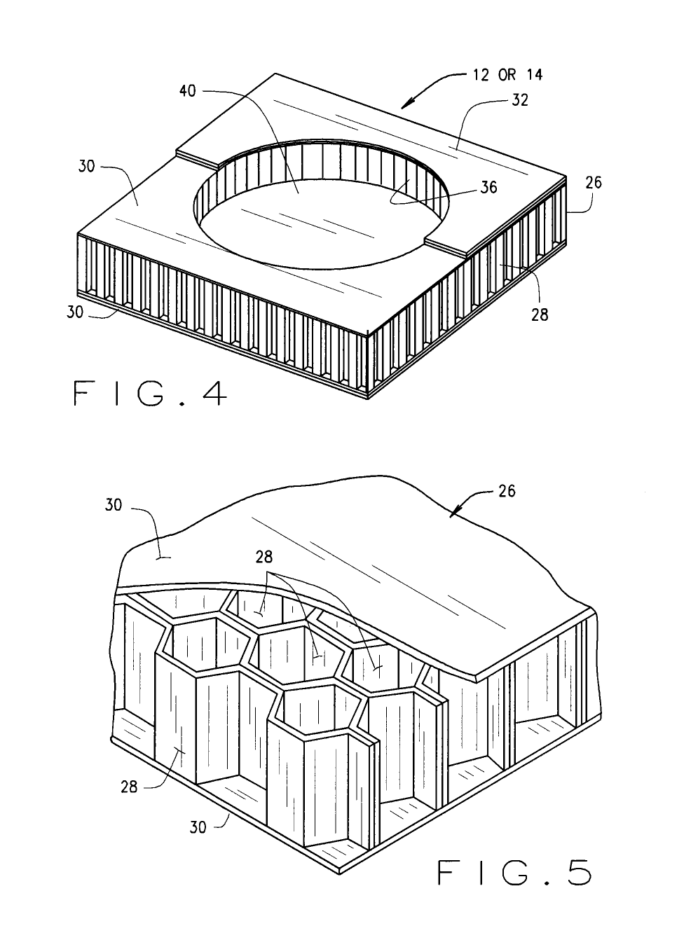

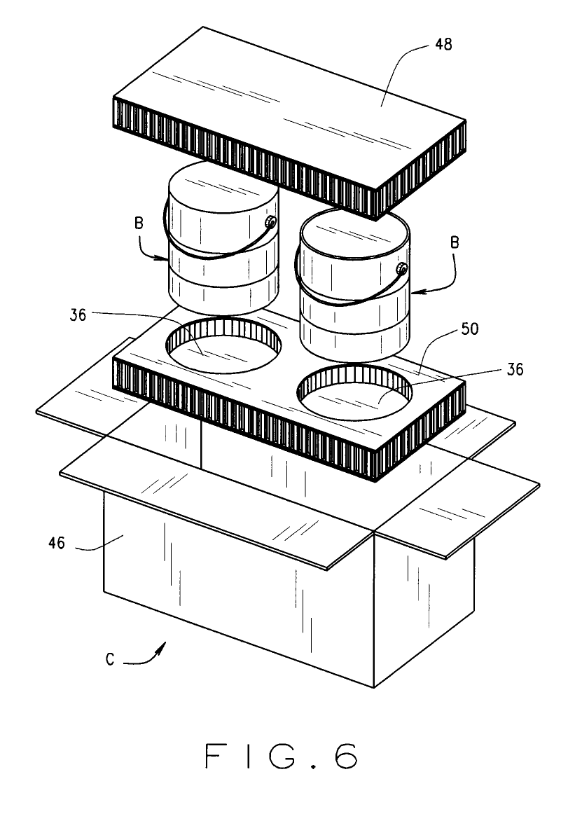

Each insert 12 and 14 fits snugly into the interior of the box 10 perpendicular to the longitudinal axis X and as such spans the space between the side walls 16 of the box 10 (FIG. 3). It includes a rectangular panel 26 (FIG. 4) that conforms to the transverse cross-sectional shape of the box 10 and is formed from paperboard honeycomb. As such it has (FIG. 5) cells 28 that lie parallel to the axis X and facer sheets 30 that extend over and are glued to the ends of the cells 28. The cells 28 should not exceed one-half inch in width (measured cell wall to cell wall). The facer sheets 30 lie parallel to each other and in a plane perpendicular to the cells 28 and to the axis X. In addition, each insert 12 and 14 has a more rigid backing 32 (FIG. 4) that extends over and is glued or otherwise attached to one of the facer sheets 30. Preferably, the backing 32 is formed from double-wall corrugated paperboard and as such has two layers of corrugations interposed between three layers of flat paper called solid fiber. Both the honeycomb panel 26 and the rigidifying backing 32 occupy the entire width and depth of the panel 12 or 14. Thus, the backing 32 for any insert 12 or 14 extends out to the peripheral margins for the panel 26 of that insert 12 or 14, including the corners.

The overlapping flaps 22 at the lower end of the box 10 are at the outset secured with one of the strips 24 of tape that bridges the lowermost flaps 22 and extends over onto the side walls 16 to which the other flaps 22 are attached. This completes the lower wall 20. The flaps 22 at the upper end of the box 10 are initially detached from each other so that end of the box 10 remains open (FIG. 2), that is to say, the upper end wall 18 does not exist in a completed form at the outset.

Each insert 12 and 14 contains a circular pocket 36 (FIG. 4) that opens out of its backing 32 and extends into its honeycomb panel 26 The pocket 36 is formed by die—cutting the backing 32 and the underlying facer sheet 30 to which the backing 32 is attached as well partially cutting the honeycomb cells 28 behind the cut, and then forcing the segment of the backing 30 that is circumscribed by the cut into the underlying cells 28. This collapses those cells 28 and transforms them into a cushion-like pad 38 (FIG. 2) that lies behind a circular base 40 that formally existed as the backing 32. The diameter of the pocket 36 generally corresponds to the diameter of the cylindrical side wall 2 on the can B, but may be up to about one-eighth inch larger. Actually, the pocket 36 should conform to the cross-section of the container that it is designed to receive and protect, whether that cross section be rectangular, oblong or some other configuration.

The lower insert 14 fits into the bottom of the box 10 against the lower end wall 20 with its pocket 36 opening upwardly into the interior of the box 10 (FIG. 2). Thereupon, the can B is lowered into the box 10 and, with its lower end aligned with the pocket 36 in the lower insert 14, is directed into the pocket 36. The can B comes to rest on the circular base 40 at the bottom of the pocket 36, its end wall 4 being immediately above the base 40. The lid 6 at the upper end of the can B now lies in the upper region of the box 10 near the flaps 22 at that upper end. Next the upper inset 12 is inserted into the interior of the box 10 with its pocket 36 opening downwardly. That pocket 36 aligns with the upper end of the can B, which it receives, and the insert 12 is advanced until the upper end of the can B comes against the circular base 40 of the pocket 36. The lid 6 of the can B lies immediately below the circular base 40 of the pocket 36, and the exposed facer sheet 30 at the upper end of the panel 26 for the upper insert 12 lies at the folds along which the flaps 22 for the upper end wall 18 of the box 10 are attached to the side walls 16. Actually, at this juncture the exposed facer sheet 30 for the upper insert 12 should lie between being flush with folds to about 3/16 inch above them. Thereupon, those flaps 22 are folded over upon themselves and over the upper insert 12 and are secured to each other with the other strip 24 of tape, which bridges the gap between the two uppermost flaps 22 and extends downwardly onto the side walls 16 to which the other flaps 22 are attached.

Thus, the can B is captured at each of the ends by the inserts 12 and 14 and the inserts 12 and 14 are confined endwise by the closed end walls 18 and 20 of the box 10, which, if the pockets 36 are shallow enough, can place the can B under slight compression. In any event, no longitudinal free motion exists between the can B and the inserts 12 and 14 or otherwise within the box 10. Moreover, the inserts 12 and 14 are confined laterally by the side walls 16 of the box 10, and the inserts 12 and 14 so confine the can B laterally. The pads 38 behind the circular bases 40 of the pockets 36 absorb impacts in the direction of the axis X. The backings 32 of the inserts 12 and 14 and to a lesser measure the honeycomb panels 26 of the inserts 12 and 14 absorb impacts in lateral directions as do the walls 16, 18 and 20 of the box 10. By extending to the corners of the box 10, the rigid backings 32 on the inserts 12 and 14 rigidify the box 10 at its corners and along its side walls 16 as well.

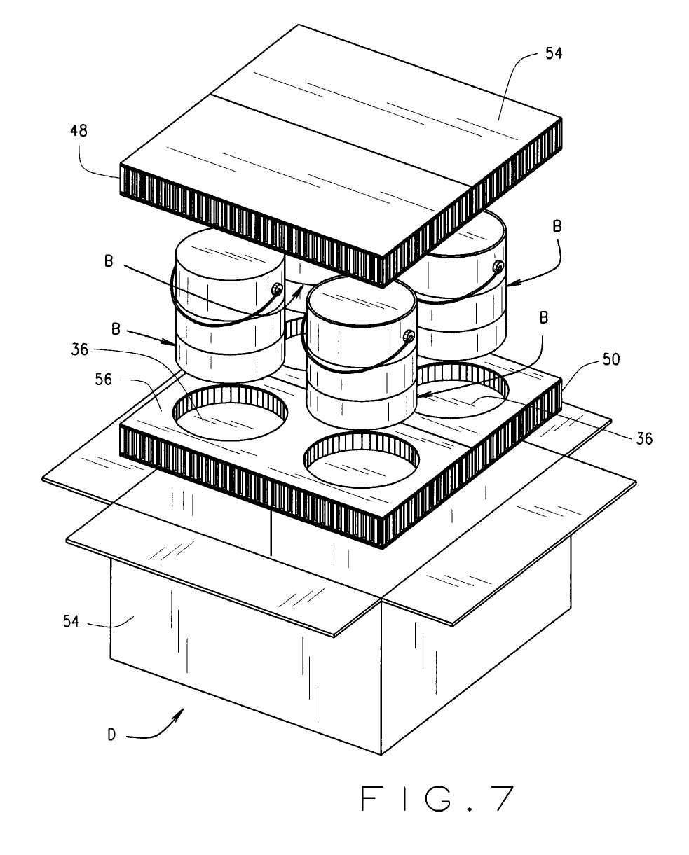

A modified package C (FIG. 6) holds two cans B. It has an elongated box 46 and elongated inserts 48 and 50, each having two pockets 36.

Another modified package D (Fig.7) has an even larger box 54 that is generally square in horizontal cross section, and it utilizes inserts 54 and 56, each having four pockets 36. Actually, two elongated inserts 50 side by side at its bottom and two elongated inserts 48 again side by side at its top may suffice for the four-pocket inserts 52 and 54.

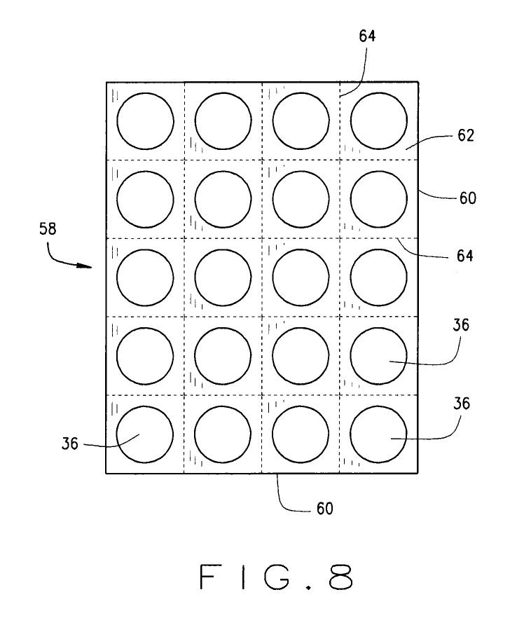

The single-inserts 12 and 14 and the double-inserts 48 and 50 and the quadruple -inserts 52 and 54 may be derived from a large slab 58 (FIG. 8) consisting of a honeycomb panel 60 and a backing 62 of double-wall corrugated paperboard glued to it. Multiple pockets 36 are formed in the slab 58 with the single stroke of a press, and then the slab 58 is provided with intermittent cuts 64, called cookie cuts, or both sides between the pockets 36 to form either single-inserts 12 and 14 or double-inserts 48 and 50, or even quadruple-inserts 52 and 54.

The inserts 12, 14, 48, and 50, 52 and 54 and the boxes 10, 46 and 52, any one or more of them, may be formed from recycled paper that can be recycled again for future use.

1. A package for protecting a can or other container, said package comprising:
a box having side walls, a bottom wall and a top wall;
lower and upper inserts in the box, each insert including a honeycomb panel that spans the space between the side walls and a backing that is attached to one face of the panel and extends the entire width of the panel, a segment of the backing and the cells of honeycomb behind that segment being depressed into the panel to provide a pocket, with the depressed segment of the backing forming the base of the pocket, the lower insert being above the bottom wall of the box with its pocket opening upwardly and the upper insert being below the top wall of the box with its pocket opening downwardly toward the pocket in the bottom wall.

2. A package according to claim 1 wherein the honeycomb panel is formed from paper and includes honeycomb cells and facer sheets extended over the ends of the cells.

3. A package according to claim 2 wherein the backing is attached to the honeycomb panel at one of the facer sheets on the panel.

4. A package according to claim 3 wherein the backing is formed from corrugated paperboard.

5. A package according to claim 3 wherein the backing is formed from double wall corrugated paperboard.

6. A package according to claim 3 wherein the box is rectangular in transverse cross section, whereby the side walls meet at four corners; and wherein the inserts, including their honeycomb panels and backings extend out to the corners of the box.

7. A package according to claim 6 wherein the honeycomb cells at the pocket are crushed to provide a pad behind the base of the pocket.

8. A package according to claim 3 wherein each of the top and bottom walls is formed from flaps that are attached to the side walls and folded over upon themselves.

9. The package according to claim 3 wherein the bottom insert is against the bottom wall of the box and the upper insert is against the top wall of the box.

10. The package of claim 9 in combination with a can having its lower end in the pocket of the lower insert and its upper end in the pocket of the upper insert.

11. The package according to claim 10 wherein no clearances exist between the upper insert and the top wall of the box, between the upper end of the can and the base of the pocket in the upper insert, between the bottom of the can and the base of the pocket in the lower insert, and between the lower insert and the bottom wall of the box.

12. The combination according to claim 11 wherein the can is compressed between the base in the pocket of the upper and lower inserts.

13. The combination according to claim 11 wherein the can is cylindrical.

14. The package of claim 3 in combination with a container having its lower end in the pocket of the lower insert and its upper end in the pocket of the upper insert.

15. A slab for providing the inserts set forth in claim 1, said slab comprising:
an enlarged honeycomb panel, having honeycomb cells and facer sheets located over the ends of the cells;
an enlarged backing attached securely to the enlarged honeycomb panel at one of its facer sheets;
there being multiple pockets opening out of the backing as a consequence of the backing having been cut to isolate segments that are forced into the honeycomb cells which is crushed behind the segments, whereby the segments form the bases of the pockets;
there being cuts through the backing and through the face sheets in the enlarged panel to define inserts that may be acquired by breaking them away from the enlarged panel and enlarged backing.
